(19) United States
(12) Patent Application Publication
(10) Pub. No.: US 2003/0120609 A1
(43) Pub. Date: Jun. 26, 2003

(54) Method, system and device for remote commercial transactions

(76) Inventors: Renzo Balagion, Padovana (IT); Claudio Altavilla, Padova (IT)

Correspondence Address: Ratner Prestia, One Westlakes Berwyn Suite 301, PO Box 980, Valley Forge, PA, 19482-0980, US

(21) Appl. No.: 10/203,240

(22) PCT Filed: Feb. 7, 2001
(86) PCT No.: PCT/IT01/00054

(30) Foreign Application Priority Data
Feb. 7, 2000 (IT) PD2000A000037

(51) Int. Cl. G06F 17/60

(52) U.S. Cl. 705/64

(57) ABSTRACT

In order to effect remote commercial and financial transactions there are provided and transmitted in wireless mode data preparatory to the financial transaction, including data identifying a means of payment (12) used and data confirming the transaction, between a remote device (1) containing the payment means and a fixed terminal (3).

### TECHNICAL FIELD

The present invention relates to a method, a system and a device for effecting remote commercial transactions.

### TECHNOLOGICAL BACKGROUND

Systems of payment by means of devices for financial-commercial transactions, such as POS terminals, ATM cash terminals and the like, have become very widespread in recent years. This spread is amply justified by the substantial practicality with which transactions can be carried out without requiring the physical exchange of money between the individual acquiring goods or services and the cashier of the commercial business where those goods or services are acquired.

POS terminals are provided with a fixed portion, equipped with a printer, a keyboard and a display, for entering the financial transaction and for reading the means of payment proposed by the user, whether this be a credit card or another similar instrument, and a mobile portion by means of which the user can key in relevant confirmation codes in order to enable the transaction to be carried out. The fixed portion is in turn connected by telephone cable to the host system of the institution managing the financial transaction.

However, those payment systems have some disadvantages which result from the fact that they require a fixed physical connection between the portion managed by the user, that managed by the retailer and the host who presides over and records the transaction. That connection is both electrical, for the power supply, and telephonic, for connection to the authorization centre.

Dedicated recognition systems are also known in which user recognition operations, which may be preparatory to subsequent financial transactions, are managed using wireless methods. Typically this is what happens in motorway network automatic recognition systems, which are known in Italy as the “Telepass” system. However, in that case the transaction is not of a financial type but one of pure recognition. The user, the time and the transit station, both on entering and on leaving, are recognised in order to communicate all of these data to a management system which only later calculates and charges a toll in deferred manner. The management system, the type of transaction, the methods and the means of payment are unambiguously determined a priori and outside the contingent control of the user.

All of these operating limits typical of the known systems substantially restrict the field of application of these devices.

### DISCLOSURE OF THE INVENTION

The object of the invention is to provide a method, a system and a device for remote commercial and financial transactions, designed structurally and functionally to avoid all of the disadvantages discussed with reference to the mentioned prior art.

The object is achieved by the invention by means of a method, a system and a device produced in accordance with the claims which follow.

### BRIEF DESCRIPTION OF THE DRAWINGS

The characteristics and advantages of the invention will become clearer from the detailed description of a preferred embodiment thereof which is illustrated, by way of non-limiting example, with reference to the appended drawings in which:

FIG. 1 is a perspective diagrammatic view of a device according to the invention;

FIG. 2 is a logic circuit diagram of the device of FIG. 1;

FIG. 3 is a schematic diagram of a system for remote financial transactions in one of its possible configurations.

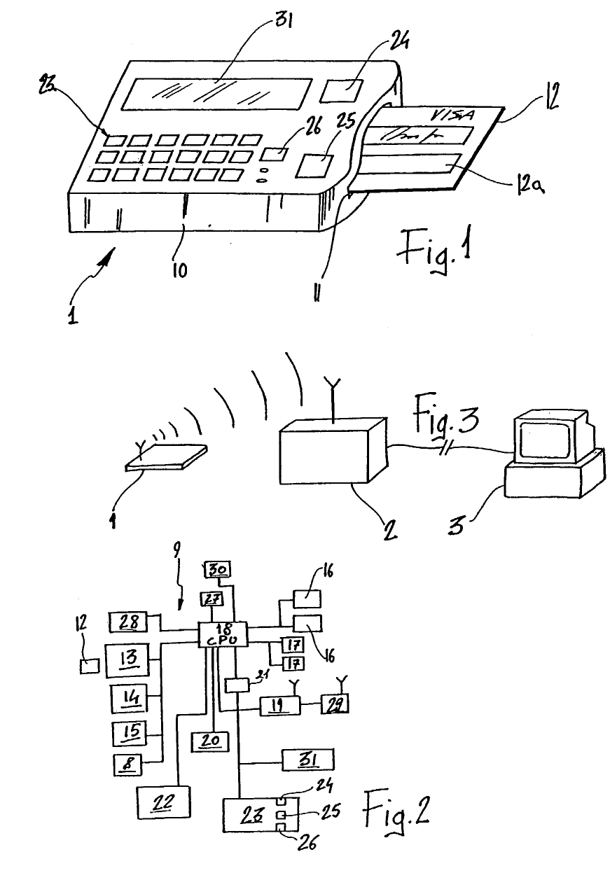

### BEST MODE FOR CARRYING OUT THE INVENTION

In the drawings, 1 generally indicates a device for remote financial transactions which is produced in accordance with the present invention. The device 1, in one of its typical configurations, cooperates operatively with a fixed transceiver station which is indicated 2 in the diagram and which is in turn connected to a fixed terminal 3.

The terminal 3 comprises a stand-alone or virtual terminal known per se and is to collect the data received from the transceiver station 2, preferably in encrypted form, in order to decode them in the language of the proprietary information system of the service and to transmit them by cable in de-encrypted form to the management information system of the service. The latter is preferably interfaced with the bank hosts or hosts of financial institutions, which provide the transaction service, for the transmission in real time of the received data. It is, however, provided that it permits off-line transmission for back-up purposes.

The transceiver station 2 comprises a transceiver apparatus of low capacity, generally less than 10 mW, with ranges which can vary from 30 to 100 metres, up to a maximum of 5-6 km depending on the electromagnetic characteristics of the operating area and any obstacles interposed between the transmitter and the receiver. Typically, these apparatuses operate in the 433.1-434.7 MHz band.

The device 1 comprises a box-form body 10 which has an approximately rectangular plan and which is provided, on one of its short sides, with a slot 11 for the insertion of a card or badge 12, for example of the type having a magnetic strip 12a. Arranged inside the body 10 is a motherboard 9, the electronic circuit of which comprises a magnetic strip reader 13, optionally a reader 14 for CP8 cards (smart cards or chip contact cards), optionally a reader 15 for “proximity” cards, one or more eprom flash memories 8 capable of containing and permitting the reading of corresponding virtual credit cards or only data stored in a different manner on the magnetic strip of a typical conventional credit card. The circuit of the motherboard 9 also comprises one or more ROM memories 16 and one or more RAM memories 17 as well as a processor 18 for the integrated management of the above-mentioned componentry. The same circuit comprises a transceiver apparatus 19, a watchdog circuit 20, a module 21 for encrypting data, a battery supply 22, an alphanumeric keyboard 23, function keys 24, 25 and 26, an acoustic indicator 27, such as a monotone buzzer, a GPS receiver module 28, an interface module 29 for GSM transceivers and an RS 232 serial interface module 30, and also a display 31.

Owing to the presence of several readers 13, 14 and 15, or of a multifunctional reader, the device 1 is able to read several types of card for effecting payments, such as ATM cards, credit cards, privative cards, with the resident data carried on a magnetic support in tracks two-three, contact CP8 cards to ISO 7816 standard and proximity chip cards. Likewise, the reading means permit the reading of similar data stored on eprom flash 8 acting as a virtual credit card. The above-mentioned data are indicated in the claims which follow as “data preparatory to the financial transaction”. These data may also comprise data emitted by means of the keyboard 23 and/or the function keys 24-26. The above-mentioned data can be stored at least temporarily in the memory 17 or can be processed directly by the processor 18 in order to be encrypted by the module 21 and sent, by means of the transceiver apparatus 19, to the fixed transceiver station 2, which is in turn interfaced with the fixed terminal 3. The amount of the transaction is picked up by the fixed transceiver station 2, assisted by the terminal 3, and transmitted to the device 1. The user, after any communication of the amount of the financial transaction in progress, will be asked to confirm the transaction by pressing, for example, the function key 24. In other cases, the user must first of all enter data which enable the amount of the transaction to be determined, for example the length of time required in a car park, for which the issuing of a confirmation ticket is required for display in the parked vehicle, and he must then press the key 24 to confirm the transaction.

In that configuration, the device is suitable for admission to protected areas and for tele-payment of the service offered (for example, a parking service), and for the tele-payment of motorway tolls and of fuel at service stations.

In addition, the device 1 can be used to communicate in “proximity” mode (or as a typical proximity card, such as those used in ski lift equipment) while using as the means of payment any of the means available, for example a traditional credit card 12 having a magnetic strip. This situation is provided for when payment for services is made to equipment provided with POS terminals having “proximity” readers, such as in ticket dispensers for parking meters or POS terminals installed in various commercial businesses.

Finally, it is provided that the RAM memory is associated with the function keys 24-26 so that, by pressing simultaneously on the key 26 and one or other of the keys 24, 25, access is obtained to two respective memory areas which, for example, store and consequently display on the display 31 the data relating to the last (ten) payments made and/or typical diary data and, respectively, data relating to the user's car, such as the year of registration and the registration number, the date of expiry of the insurance stamp, servicing tickets, etc. By programming the relevant expiry dates, the user is warned of them by means of the buzzer-type acoustic indicator 27.

The invention thus achieves the object proposed and permits numerous other advantages, such as the diary and expiry date monitoring service, the monitoring of payments carried out, the optional support of telecommunications by means of the GSM module associated therewith, the optional support of satellite navigation systems by means of the GPS module and the GSM module acting as a support thereof, and also the monitoring of data relating, for example, to one's car, such as the registration number, the year of registration, the expiry dates of policies and tickets, etc.

1. A method for remote commercial and financial transactions, including the stage of wireless transmission of data preparatory to the financial transaction between a remote device (1) containing a payment means (12) and a fixed terminal (3), the data including data identifying the means of payment used and data confirming the transaction.

2. A method according to claim 1, wherein the data are transmitted in encrypted form.

3. A device for remote commercial and financial transactions comprising, inside a box-form body (10), a motherboard (9) having an electronic circuit including:
reading means (13, 14, 15) for reading a payment means (12) outside or resident in the box-form body,
data-input means (23, 24, 25, 26),
a processor (18) associated with the reading means (13, 14, 15) and the input means (23, 24, 25, 26) for processing data entered by means of the input means (23, 24, 25, 26) and/or data read by the reading means (13, 14, 15), and preparatory to the financial transaction,
transceiver means (19) for transmitting the data to a remote station (2) in real time and with a wireless connection.

4. A device according to claim 3, wherein the data-input means comprise a receiving station (19, 29).

5. A device according to claim 4, wherein the receiving station (29) belongs to the transceiver means (19).

6. A device according to one or more of claims 3 to 5, wherein the input means comprise a keyboard (23).

7. A device according to one or more of claims 3 to 6, wherein the electronic circuit comprises cryptographic means (21) for encrypting the data transmitted by the transceiver means (19).

8. A device according to one or more of claims 3 to 7, wherein the input means (23, 24, 25, 26) comprise means (24) for the voluntary confirmation of the transaction.

9. A device according to one or more of claims 3 to 8, wherein the reading means (13, 14, 15) are provided for the recognition of a combination of one or more of the following payment means: magnetic-strip cards, CP8 cards, proximity cards, resident chip cards, non-volatile memory circuits resident in the box-form body (10).

10. A device according to one or more of claims 3 to 9, wherein the electronic circuit comprises memory means (8, 16, 17) for storing the data preparatory to the transaction and/or one or more data bases extraneous to the transaction.

11. A system for remote commercial and financial transactions, including at least one device according to one or more of claims 3 to 10, capable of remote connection in wireless mode to a fixed transceiver station (2) which is in turn connected to a management information system of the service (3)
